(19) United States
(12) Patent Application Publication
(10) Pub. No.: US 2007/0109644 A1
(43) Pub. Date: May 17, 2007

(54) Brightness enhancement film

(75) Inventors: Fu-Ming Chuang, Hsinchu (TW); Bih-Chang Wang, Hsinchu (TW)

Correspondence Address: BIRCH STEWART KOLASCH & BIRCH, PO BOX 747, FALLS CHURCH, VA, 22040-0747, US

(73) Assignee: Young Optics Inc.

(21) Appl. No.: 11/582,299

(22) Filed: Oct. 18, 2006

(30) Foreign Application Priority Data
Nov. 11, 2005 (TW) 94139643

(51) Int. Cl. G02B 5/18

(52) U.S. Cl. 359/569; 359/558

(57) ABSTRACT

A brightness enhancement film, which is disposed beyond a light module, the light source module emits light upward to and through the brightness enhancement film. The brightness enhancement film is composed of a substrate and a diffractive optical element which is disposed on a surface of the substrate, the diffractive optical element collimates a direction of the light after the light is passing through the diffractive optical element.

### (1) FIELD OF THE INVENTION

The present invention generally relates to a brightness enhancement film, more particularly to a brightness enhancement film applied to a backlight module.

### (2) DESCRIPTION OF THE PRIOR ART

Please refer to FIG. 1A, which illustrates an exploded diagram of a backlight module of a prior art. Herein the backlight module is a side type backlight module. As shown in FIG. 1A, a light guide plate 6 and a light source 4 nearby the light guide plate 6 are formed as a light source module 5. The light source 4 is a row of LEDs with point type or a linear light source as cold cathode fluorescent lamp (CCFL).

A diffusion pattern 9 is formed on a bottom surface of the light guide plate 6 through an embossing machining or a diffused reflection ink printing process. A reflection plate 8 is disposed on a bottom of the light guide plate 6. The light guide plate 6 guides light from the light source 4 upward passing through the diffusion pattern 9 and the reflection plate 8. However, there are two problems for the light emerging from the light guide plate 6 that the emitted light is scattering light and the direction of the emitted light is oblique to the normal of the light guide plate 6 since the light source 4 is disposed aside. Hence an incident angle θ is exist between the highest scattering intensity light and the normal of a surface of the light guide plate 6.

A first diffusion film 10, a first brightness enhancement film 12, a second brightness enhancement film 14, and a second diffusion film 16 are disposed upon the light guide plate 6 in the order from bottom to top.

The first diffusion film 10 homogenizes the light from the light guide plate 6 and decreases the transmission angle of the first diffusion film 10 corresponding to the incident angle θ so as to correct the light from the light guide plate 6. Refer to FIG. 1B, which illustrates a partial diagram of the backlight module of the prior art in FIG. 1A. The first brightness enhancement film 12 is composed of a plurality of prism structures arranged along X direction and paralleled each other. The plurality of prism structures collimates the scattering light along X direction to eliminate the angle between the light and the normal of the light guide plate 6. The incident angle and the transmission angle are defined as an angle between the light and the normal of the light guide plate 6.

As FIG. 1B shows, the second brightness enhancement film 14 is composed of a plurality of prism structures arranged along Y direction and paralleled each other. The plurality of prism structures collimates the scattering light along Y direction. Herein Y direction is perpendicular to X direction. Thereafter, the second brightness enhancement film 14 and the first brightness enhancement film 12 collimate the light simultaneously, hence the emitted light from the second brightness enhancement film 14 nearly parallel to the normal of the second brightness enhancement film 14. Generally the first brightness enhancement film 12 and the second brightness enhancement film 14 are composed of a plurality of prism structures and made by a way of applying ultra violet curing resin onto an plastic plate, then stamping the ultra violet curing resin, and finally irradiating the ultra violet curing resin with UV light.

The second diffusion film homogenizes the light before the light is projected onto a LCD panel (not shown in the figure) so as to even the image of the LCD panel.

However, the structure mentioned above has more layers to collimate the light. It causes that not only cost is increased but also fabricating processes are complicated. Moreover, too many brightness enhancement films make a phenomenon of total internal reflection (TIR), which decreases the brightness of the light produced by the backlight module 2. The phenomenon of TIR is happened by saw-toothed structures of upper surfaces of the first and the second brightness enhancement film, the two incline planes of each sawtooth result total reflection phenomenon of the light, such as an optical path of the total reflection 20 in order to turn the light back to a lower portion of the backlight module 2.

Additionally, the direct type backlight module also needs a plurality of brightness enhancement films to collimate emitted light, therefore the problem mentioned foregoing exists as well.

### SUMMARY OF THE INVENTION

The primary objective of the present invention discloses a brightness enhancement film. That is, the brightness enhancement film has less optical elements, but with the merits of correcting and collimating light from alight source module in order to homogenize the light guided upward by a backlight module and enhance the brightness.

The present invention is related to the brightness enhancement film, a light source module is nearby and disposed under a bottom surface of the brightness enhancement film. The brightness enhancement film has a diffractive optical elements (DOE). The light source module emits light upward to and through the brightness enhancement film, and the brightness enhancement film is composed of a substrate and a diffractive optical element which is disposed on a surface of the substrate; wherein the diffractive optical element collimates the light direction after the light is passing through the diffractive optical element, at the time of the light emitting onto a surface of the diffractive optical element, the incident angle is defined between the normal of the surface of the diffractive optical element and the light-incident path, continuously at the time of the light leaving out the surface of the diffractive optical element, the transmission angle is defined between the normal of the surface of the diffractive optical element and the light-transmission path, the light is defined as scattering light from the light module, and the incident angle is the included angle between highest scattering intensity light and the normal of the brightness enhancement film. Besides, the structure of the diffractive optical element is capable of collimating the light from the light module.

Thus, disposing the diffractive optical element of the brightness enhancement film on the optical path decreases the amount of optical elements so as to correct and collimating the light. Hence, the light guided upward by the backlight module is homogenized and enhanced.

All the spirits and scope of the present invention will be understood by the detail and illustration described in following.

### BRIEF DESCRIPTION OF THE DRAWINGS

Other features and advantages of this invention will become more apparent in the following detailed description of the preferred embodiments of this invention, with reference to the accompanying drawings, in which:

FIG. 1A illustrates an exploded diagram of a backlight module of a prior art;

FIG. 1B illustrates a partial diagram of the backlight module of the prior art in FIG. 1A.

FIG. 2A illustrates a side-view structure diagram of a side type backlight module and an x-direction optical path of light according to a first preferred embodiment of the present invention;

FIG. 2B illustrates a partial diagram of the backlight module of the first preferred embodiment in FIG. 2A.

FIG. 3 illustrates a schematic view of optical paths along the X and Y directions according to the present invention;

FIG. 4A illustrates a schematic top view of a brightness enhancement film in FIG. 2A;

FIG. 4B illustrates a schematic cross-section view of a brightness enhancement film in FIG. 2A;

FIG. 5 illustrates a schematic top cross-section view of the brightness enhancement film of the present invention;

FIG. 6 illustrates a flow chart of fabricating a diffractive optical element of the present invention;

FIG. 7A illustrates a schematic view of a first preferred embodiment of the brightness enhancement film and a diffusion layer of the present invention;

FIG. 7B illustrates a partial diagram of the brightness enhancement film and a diffusion layer of the first preferred embodiment in FIG. 7A.

FIG. 8 illustrates a schematic relation view of the brightness and the incident angle according to FIG. 7, herein the light source of the backlight module is CCFL;

FIG. 9A illustrates a schematic view of a second preferred embodiment of the brightness enhancement film and the diffusion layer of the present invention;

FIG. 9B illustrates a partial diagram of the brightness enhancement film and a diffusion layer of the second preferred embodiment in FIG. 9A;

FIG. 10A illustrates a schematic view of a third preferred embodiment of the brightness enhancement film and the diffusion layer of the present invention; and

FIG. 10B illustrates a partial diagram of the brightness enhancement film and a diffusion layer of the third preferred embodiment in FIG. 10A.

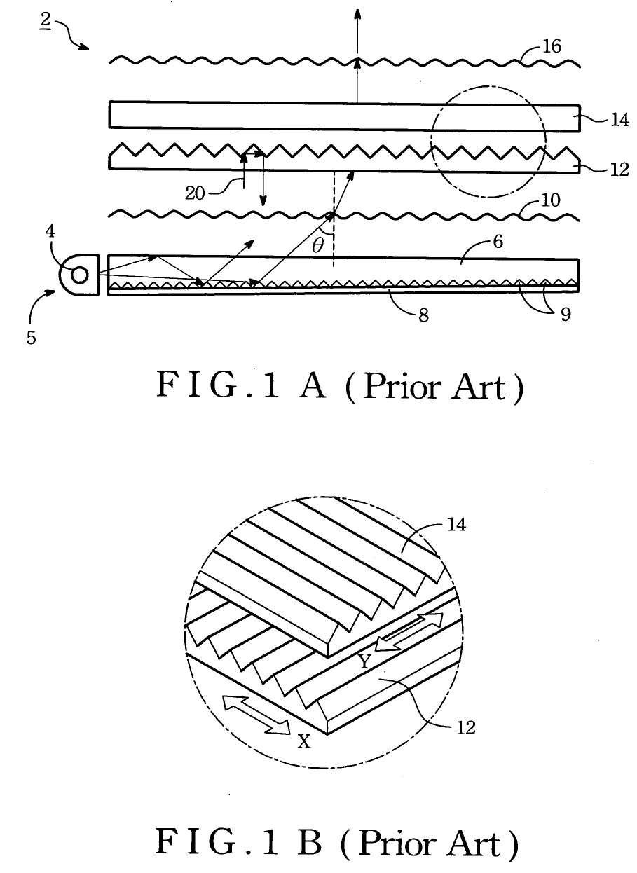

### DESCRIPTION OF THE PREFERRED EMBODIMENT

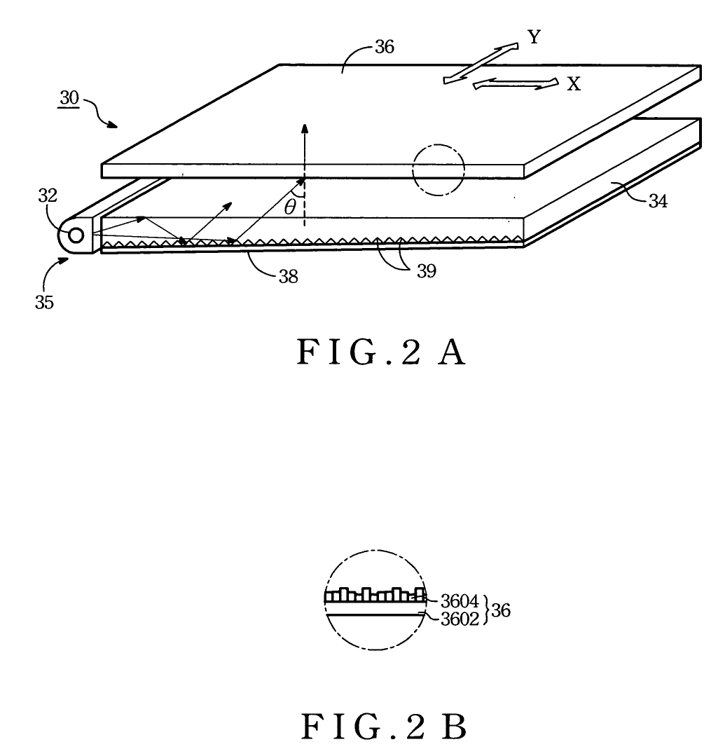

Generally, there are two types of backlight modules, such as a side type backlight module and a direct type backlight module. Firstly, a side type backlight module is described as a first preferred embodiment. The side type backlight module is used as a light source. Please refer to FIG. 2A, which illustrates a side-view structure diagram of a side type backlight module 30 and an x-direction optical path of a first preferred embodiment of the present invention. The side type backlight module 30 includes a light source module 35 and a brightness enhancement film 36, wherein the light source module 35 is composed of a light source 32 and a light guide plate 34. Refer to FIG. 2B, which illustrates a partial diagram of the backlight module of the first preferred embodiment in FIG. 2A. As FIG. 2B shows, the brightness enhancement film 36 is composed of a substrate 3602 and a diffractive optical element 3604, the diffractive optical element 3604 is disposed on one surface of the substrate 3602. The light emitted from the light source 32 is along the X direction.

The light source 32 is disposed on one side of the light guide plate 34, the light source 32 could be a row of point light sources, or a linear light source such as cold cathode fluorescent lamp (CCFL). In this embodiment, a linear light source is applied herein. The light guide plate 34 guides light from the light source 32 upward through the diffusion pattern 39 and the reflection plate 38.

The brightness enhancement film 36 is disposed upon the light guide plate 34, and the diffractive optical element 3604 collimates a transmission angle of a light leaving out a surface of the diffractive optical element 3604 after the light with an incident angle θ from the light guide plate 34 passing through the diffractive optical element 3604. That is, the transmission angle is smaller after collimation. At the time of the light emitting onto a surface of the diffractive optical element 3604, the incident angle is defined between the normal of the surface of the diffractive optical element 3604 and the light-incident path, continuously at the time of the light leaving out the surface of the diffractive optical element 3604, the transmission angle is defined between the normal of the surface of the diffractive optical element 3604 and the light-transmission path, the light is defined as scattering light from the light source module , and the incident angle is the included angle between highest scattering intensity light and the normal of the brightness enhancement film. Besides, the structure of the diffractive optical element 3604 is capable of collimating the light from the light guide plate 34.

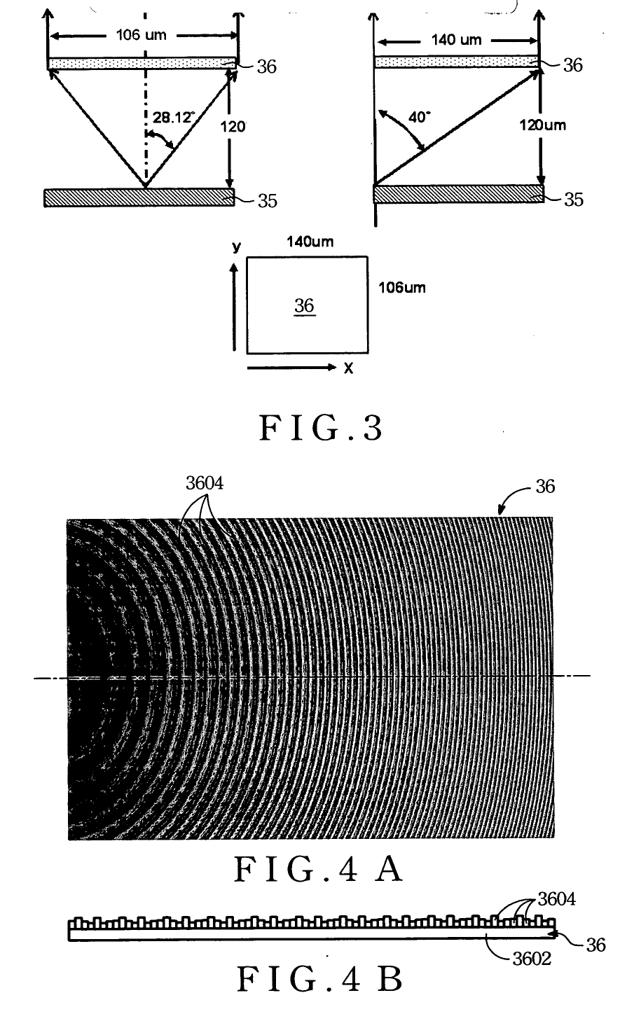

Please refer to FIG. 3, which illustrates a schematic view of optical paths along the X and Y directions of the present invention. The optical paths of the light are to confer for further description, for example, the sizes of the brightness enhancement film 36 is 140 μm×160 μm, the directions of X direction and Y direction is defined, and the light source 32 is disposed aside of the Y direction.

The brightness enhancement film 36 provides a function of light collimation, for instance, along the Y direction, the aligned angle of the light from the light source module 35 is about 56.24 degrees. Along the X direction, the incident angle of the light from the light source module 35 is about 40 degrees. Therefore, the emitted light from the brightness enhancement film is much even and brighter.

Following is to describe the machining way for the diffractive optical element 3604. Thus, a backplane is formed firstly. A pattern on the backplane is shifted to a surface of the diffractive optical element 3604 through hot-pressed processes and injection molding process (or other transferring processes) diffractive optical element. The diffractive optical element 3604 with the pattern is continuously formed on the substrate 3602 to produce the brightness enhancement film 36. The backplane may be fabricated by laser machining, laser beam machining, lithographing, or other traditional mechanical methods.

Refer to FIG. 4A and FIG. 4B, which illustrate a schematic top view and a cross-section view of a brightness enhancement film 36 in FIG. 2A respectively. The substrate 3602 is made of polymethyl methacrylate (PMMA), polyethylene propylene, or other transparent materials.

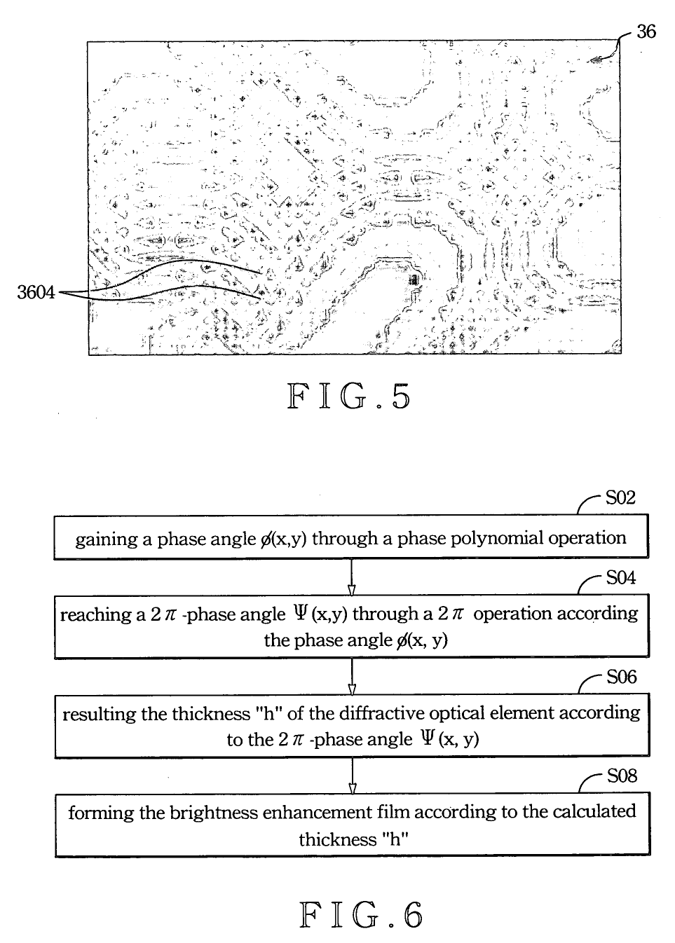

In another embodiment, the light source 32 adjacent to the light guide plate 34 is a point light source as LEDs. With reference to FIG. 5, which illustrates a schematic top cross-section view of the brightness enhancement film 36 of the present invention.

From FIG. 4 and FIG. 5, it can be seen that different light sources result in different patterns of diffractive optical elements 3604.

Under the condition of the light source 32 being a linear light source, the problem of the scattering phenomenon along Y direction is not serious. Otherwise, the problem of the scattering phenomenon along Y direction is serious under the condition of a point light source. The present invention obviously may collimate the scattered light along Y direction.

Moreover, while the backlight module is a direct type backlight module, the incident angle θ is smaller than a side type backlight module. Although the need to correct the incident angle of the direct type backlight module is not that important, the brightness enhancement film 36 of the present invention still can play the role of light correction and collimation simultaneously.

Please refer to FIG. 6, the fabricating method of the diffractive optical element 3604 comprises following steps of:
S02: gaining a phase angle Φ(x,y) through a phase polynomial operation according to the incident angle θ, that the light is defined as scattering light from the light module, and the incident angle θ is the included angle between highest scattering intensity light and the normal of the brightness enhancement film 36,
S04: reaching a 2π-phase angle Ψ(x,y) through a 2π operation according the phase angle Φ(x, y),
S06: resulting the thickness “h” of the diffractive optical element by way of a height operation of the diffractive optical element according to the 2π-phase angle Ψ(x, y), and
S08: disposing the diffractive optical element 3604 on the surface of the substrate 3602 according to the calculated thickness “h” so as to form the brightness enhancement film 36, that the diffractive optical element 3604 is able to decrease the transmission angle and collimate the light from the light source module simultaneously.

What foregoing mentioned about the phase polynomial operation is defined as

$$∅ ( x , y ) = {\sum }_{j} Cj \cdot {X}^{m} {Y}^{n} ,$$

wherein m and n are arbitrary constants, and “j” is in accordance with

$$j = \frac{\{ {( m + n )}^{2} + m + 3 n \}}{2} .$$

Continuously, the polynomial operation is applied to determine an ideal Cj to represent the phase angle Φ.

For instance, according to the condition of

$$j = \frac{\{ {( m + n )}^{2} + m + 3 n \}}{2} ,$$

a function equation to fit with

$$∅ ( x , y ) = {\sum }_{j} Cj \cdot {X}^{m} {Y}^{n}$$

is that: Φ=C₁X+C₂Y+C₃X²+C₄XY+C₅Y²+C₆X³+C₇X²Y+C₈XY²+C₉Y³+ . . . After the phase polynomial operation being performed, a set of the best values C₁, C₂, C₃, C₄, C₅, C₆, C₇, C₈, C₉g, etc. are now derived. Herein the operation processes may not be given details because it could be performed through general optical design softwares.

In one embodiment, the incident angles of the light source module 35 along X direction and Y direction are 31.2 degrees and 0 degree respectively. And assuming the following conditions: the material of the diffractive optical element 3604 is PMMA, and the center wavelength λ₀ of the light is 587 nm, the refractive index n(λ₀) of the diffractive optical element 3604 to the light (center wavelength=587 nm) is 1.49, and the value of “j” is 50. The horizontal viewing angle is designed as 60 degrees, and the vertical viewing angle is designed as 35 degrees; the thickness of the substrate 3602 is 180 micron meter. After the optimization operation, the series of calculated Cj are shown as the following table:

| | | | | |
|---|---|---|---|---|
| C1: −4.1078E−01 | C2: −1.0159E−07 | C3: −4.0629E+00 | C4: 1.3503E−04 | C5: −2.5498E+00 |
| C6: −1.1329E+01 | C7: 3.8116E−04 | C8: −7.0188E+00 | C9: −1.9720E−05 | 0 |
| C11: −5.8763E−02 | C12: 1.5909E+02 | C13: −1.2890E−01 | C14: −4.4928E+02 | C15: 2.5740E+03 |
| C16: −1.6549E−01 | C17: 3.5531E+03 | C18: −2.2087E−01 | C19: 1.7271E+03 | C20: 2.3199E−02 |
| C21: −4.7870E+00 | C22: −8.7478E−04 | C23: 8.6639E−02 | C24: −6.4848E−04 | C25: 3.1871E−02 |
| C26: −1.0882E−03 | C27: 3.2321E−02 | C28: −4.9276E−03 | C29: 5.4298E−01 | C30: −4.8752E−03 |
| C31: 6.9150E−02 | C32: −4.8775E−03 | C33: −4.8061E−03 | C34: −4.8770E−03 | C35: −8.1697E−05 |
| C36: −4.4290E−02 | C37: −4.8369E−03 | C38: −4.8923E−03 | C39: −4.8606E−03 | C40: −4.8795E−03 |
| C41: −4.8579E−03 | C42: −4.8788E−03 | C43: −4.8798E−03 | C44: −4.9988E−03 | C45: −4.8782E−03 |
| C46: −2.2200E−03 | C47: −4.8777E−03 | C48: −4.8769E−03 | C49: −4.8778E−03 | C50: −4.8768E−03 |

Then the phase angle φ(x,y) is obtained by the equation of

$$∅ ( x , y ) = {\sum }_{j} Cj \cdot {X}^{m} {Y}^{n} .$$

However, the calculated phase angle φ(x, y) is suitable to be as a parameter to fabricate a refracted element, but the thickness of the refracted element is too thick to be a layer-type optical element within the backlight module 30. Therefore, a 2π-phase angle Ψ(x,y) must be reached by way of the 2π phase operation for a diffractive element.

The 2π phase operation uses the equation of Ψ(x,y)=[Φ(x,y)]mod2π. The calculated 2π-phase angle Ψ(x,y) is suitable for a diffractive element, which has a thinner thickness and ease to be a layer-type element of the backlight module 30.

A thickness distributed function of each portion of the brightness enhancement film 36 is defined as the thickness of a position having a coordinate (x, y), wherein the origin of the coordinates is defined as the center of each portion. The thickness “h” of the diffractive optical element 3604 is calculated through the equation of _{h(x,y)}={λ0/[(n(λ0)−1 ]}*{Ψ(x,y)/2π}. According to the known 2π-phase angle Ψ(x,y), the wavelength λ₀ of the incident light, and the refractive index n(λ₀) of the diffractive optical element 3604, the thickness “h” of every specific position is determined precisely.

The thickness “h” of the diffractive optical element 3604 is the most important factor of designing the brightness enhancement film 36, it influences the efficiency of the light correction and collimation.

In other embodiments, no matter a side type backlight module or a direct type module is applied, the backlight module 30 further includes a diffusion layer 50 to assist homogenizing the emitted light. The position of the diffusion layer 50 is discussed hereinafter.

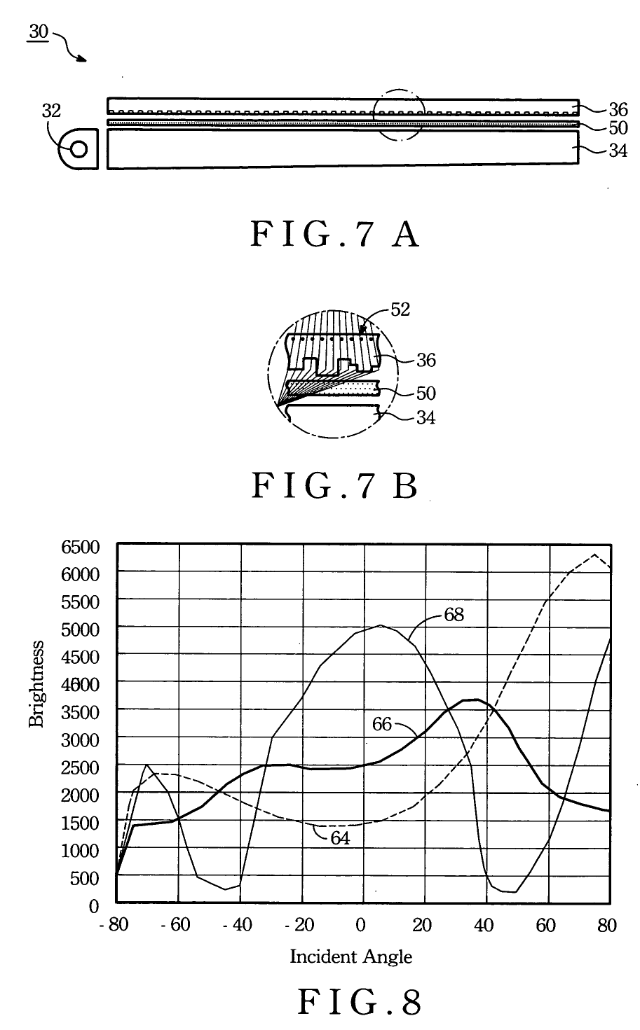

Please refer to FIG. 7A, which illustrates a schematic view of a first preferred embodiment of the brightness enhancement film 36 and the diffusion layer 50 of the present invention. The diffusion layer 50 is disposed between the light source module 35 and the brightness enhancement film 36, the diffractive optical element 3604 is disposed on the lower surface of the substrate 3602, and a matt layer 52 is disposed on the upper surface of the substrate 3602, as FIG. 7B shows. The diffusion layer 50 and the matt layer 52 may homogenize the phenomenon of the light, and the matt layer 53 is directly formed on the surface of the brightness enhancement film 36 in order to lower the fabricating cost.

With reference to FIG. 8, which illustrates a schematic relation view of the brightness and the incident angle according to FIG. 7, herein the light source of the backlight module is CCFL. The ordinate is brightness, and the abscissa is incident angle. The incident angle near the middle position of the abscissa is nearly 0 degree, and the three curves represent light 64 from the light guide plate 34, light 66 from the diffusion layer 50, and the light 68 from the brightness enhancement film 36 respectively.

From FIG. 8, it is seen that the diffusion layer 50 has the function of preliminary correction of light (decreasing the value of the transmission angle), and the brightness enhancement film 36 aligns the light substantially. Comparing to the TIR phenomenon mentioned in the prior art, the present invention eliminate numbers of elements, fabricating processes, and enhances intensity of light.

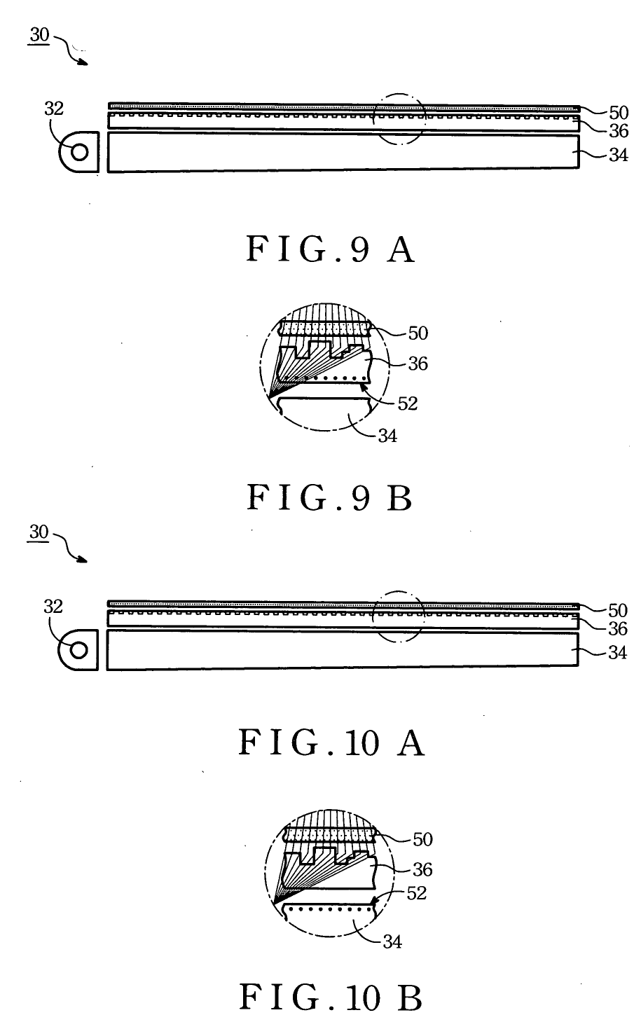

Please refer to FIG. 9A, which illustrates a schematic view of a second preferred embodiment of the brightness enhancement film 36 and the diffusion layer 50 of the present invention. Herein the diffusion layer 50 is disposed upon the brightness enhancement film 36, the diffractive optical element element 3604 is disposed on the upper surface of the substrate 3602, and the matt layer 52 is formed on the lower surface of the substrate 3602, as FIG. 9B shows.

Please refer to FIG. 10A, which illustrates a schematic view of a third preferred embodiment of the brightness enhancement film 36 and the diffusion layer 50 of the present invention. Herein the diffusion layer 50 is disposed upon the brightness enhancement film 36, the diffractive optical element 3604 is disposed on the upper surface of the substrate 3602, and the matt layer 52 is formed on the upper surface of the light guide plate 34, as FIG. 10B shows. The embodiments described in FIGS. 7A-10B show several types according to preferred embodiments based on the brightness enhancement film 36 of the present invention, and they are not to restrict the limitation of the present invention.

Through the brightness enhancement film 36 and the methods of designing the diffractive optical element 3604 thereof, the brightness enhancement film 36 is disposed on the optical path of the backlight module 30. By using less elements, the goal of light correction and light collimation is achieved simultaneously, and it is resulted in that the light emitted by the backlight module 30 is even and with high intensity. Furthermore, the brightness enhancement film 36 shields the diffusion pattern 39 that on the bottom surface of the light guide plate 34, and hence avoid that the diffusion pattern can be seen directly from the top of the backlight module 30.

While the present invention has been particularly shown and described with reference to such preferred embodiments, it will be understood by those skilled in the art that various changes in form and detail may be without departing from the spirit and scope of the present invention.

What is claimed is:

1. A brightness enhancement film disposed beyond a light module, which emits light upward to and through the brightness enhancement film, the brightness enhancement film comprising:
a substrate; and
a diffractive optical element disposed on a surface of the substrate;
wherein the diffractive optical element collimates a direction of the light after the light passes through the diffractive optical element, at the time of the light emitting onto a surface of the diffractive optical element, the incident angle is defined between the normal of the surface of the diffractive optical element and the light-incident path, continuously at the time of the light leaving out the surface of the diffractive optical element, the transmission angle is defined between the normal of the surface of the diffractive optical element and the light-transmission path.

2. The brightness enhancement film of claim 1, wherein the light is defined as scattering light from the light module, and the incident angle is the included angle between highest scattering intensity light and the normal of the brightness enhancement film.

3. The brightness enhancement film of claim 2, wherein the thickness “h” of the brightness enhancement film is calculated by the steps of:
gaining a phase angle Φ(x, y) through a phase polynomial operation according to the incident angle θ;
reaching a 2π-phase angle Ψ(x,y) through a 2π operation according the phase angle Φ(x, y); and
resulting the thickness “h” of the diffractive optical element by way of a height operation of the diffractive optical element according to the 2π-phase angle Ψ(x, y).

4. The bright enhancement film of claim 3, wherein the phase polynomial operation is defined as
$$∅ ( x , y ) = {\sum }_{j} Cj \cdot {X}^{m} {Y}^{n} ,$$
m and n are arbitrary constants, and “j” is in accordance with
$$j = \frac{\{ {( m + n )}^{2} + m + 3 n \}}{2} .$$

5. The bright enhancement film of claim 3, wherein the 2π-phase operation is based on the equation: Ψ(x, y)=[Φx, y)]mod2π.

6. The bright enhancement film of claim 5, wherein the thickness “h” is based on the equation: h(x,y)={λ₀/[n(λ₀)−1]}*{Ψ(x,y)/2π}.

7. The bright enhancement film of claim 1 is applied to a backlight module.

8. The bright enhancement film of claim 7, wherein the backlight module further comprises a diffusion layer.

9. The bright enhancement film of claim 8, wherein the diffusion layer is disposed between the light source module and the bright enhancement film, the diffractive optical element is disposed on a lower surface of the substrate, and a matt layer is disposed on an upper surface of the substrate.

10. The bright enhancement film of claim 8, wherein the diffusion layer is disposed beyond the brightness enhancement film, the diffractive optical element is disposed on an upper surface of the substrate, and a matt layer is disposed on a lower surface of the substrate.

11. The bright enhancement film of claim 8, wherein the diffusion layer is disposed beyond the brightness enhancement film, and the diffractive optical element is disposed on an upper surface of the substrate, and a matt layer is disposed on an upper surface of the substrate.

12. The brightness enhancement film of claim 1, wherein the light source module is selected from the group consisted of a direct type backlight module and a side type backlight module.
